(19) United States
(12) Patent Application Publication
(10) Pub. No.: US 2024/0372099 A1
(43) Pub. Date: Nov. 7, 2024

(54) ELECTRODE FOR SOLID-STATE BATTERY, METHOD OF MANUFACTURING THE SAME, SOLID-STATE BATTERY, AND BATTERY PACKAGE

(71) Applicant: MURATA MANUFACTURING CO., LTD., Kyoto (JP)

(72) Inventor: Daisuke ITO, Kyoto (JP)

(21) Appl. No.: 18/774,094

(22) Filed: Jul. 16, 2024

Related U.S. Application Data
(63) Continuation of application No. PCT/JP2023/009129, filed on Mar. 9, 2023.

(30) Foreign Application Priority Data
Mar. 25, 2022 (JP) 2022-049857

(51) Int. Cl. H01M 4/62; H01M 4/02; H01M 4/04; H01M 10/0562

(52) U.S. Cl. CPC H01M 4/622; H01M 4/0416; H01M 10/0562; H01M 2004/021; H01M 2300/0071; H01M 2300/008

(57) ABSTRACT

An electrode for a solid-state battery having superior performance is provided. The electrode for a solid-state battery includes active material particles, a binder, and an inorganic solid-state electrolyte. The active material particles each have a porous structure having a pore inside. The binder is provided in a gap between the active material particles. The binder includes a hydrophilic organic compound. The pore is impregnated with the inorganic solid-state electrolyte. The inorganic solid-state electrolyte is meltable at a temperature lower than a volatilization temperature of the binder.

### CROSS REFERENCE TO RELATED APPLICATIONS

The present application is a continuation of PCT patent application no. PCT/JP2023/009129, filed on Mar. 9, 2023, which claims priority to Japanese patent application no. 2022-049857, filed on Mar. 25, 2022, the entire contents of which are incorporated herein by reference.

### BACKGROUND

The present technology relates to an electrode, for a solid-state battery, including a solid-state electrolyte; a method of manufacturing the same; a solid-state battery including the electrode for a solid-state battery; and a battery package including the electrode for a solid-state battery.

Various kinds of electronic equipment, including mobile phones, have been widely used. Such widespread use has promoted development of a secondary battery as a power source that is smaller in size and lighter in weight and allows for a higher energy density.

The secondary battery includes a positive electrode, a negative electrode, and an electrolyte that are contained inside an outer package member. Recently, a solid-state battery has been developed that is a secondary battery including a solid-state electrolyte instead of a liquid or gel electrolyte that includes a material such as an organic solvent.

### SUMMARY

The present technology relates to an electrode, for a solid-state battery, including a solid-state electrolyte; a method of manufacturing the same; a solid-state battery including the electrode for a solid-state battery; and a battery package including the electrode for a solid-state battery.

Consideration has been given in various ways to improve performance of a solid-state battery, as described in the literatures in the above citation list. There is, however, room for improvement in terms of the performance of the solid-state battery.

It is desirable to provide an electrode, for a solid-state battery, that is to be used to provide a solid-state battery having a superior performance.

An electrode for a solid-state battery of an embodiment of the present disclosure includes active material particles, a binder, and an inorganic solid-state electrolyte. The active material particles each have a porous structure having a pore inside. The binder is provided in a gap between the active material particles. The binder includes a hydrophilic organic compound. The pore is impregnated with the inorganic solid-state electrolyte. The inorganic solid-state electrolyte is meltable at a temperature lower than a volatilization temperature of the binder.

According to the electrode for a solid-state battery of the embodiment of the present disclosure, the pore of each of the active material particles is impregnated with the inorganic solid-state electrolyte that is meltable at the temperature lower than the volatilization temperature of the binder including the hydrophilic organic compound. This makes it possible to increase an area of an interface at which the active material particles and the inorganic solid-state electrolyte are in contact with each other, and to thereby improve an electrode reactant conductive property. Accordingly, it is possible to achieve superior performance when the electrode is applied to a solid-state battery. For example, it is possible to allow for fast charging or to obtain high output.

Note that effects of the present disclosure are not necessarily limited to those described herein and may include any of a series of effects described below in relation to the present disclosure.

### BRIEF DESCRIPTION OF THE FIGURES

FIG. 1 is a schematic sectional diagram illustrating an example of a configuration of an electrode for a solid-state battery as a first embodiment of the present disclosure.

FIG. 2 is a flowchart illustrating an example of a manufacturing process of the electrode for a solid-state battery illustrated in FIG. 1.

FIG. 3 is a schematic sectional diagram illustrating a configuration of a battery package as a second embodiment of the present disclosure.

FIG. 4 is a sectional diagram illustrating a configuration of a solid-state battery illustrated in FIG. 3.

FIG. 5 is a schematic sectional diagram illustrating an example of a configuration of a solid-state electrolyte layer illustrated in FIG. 4.

### DETAILED DESCRIPTION

The present disclosure is described below in further detail including with reference to the drawings. Note that a “solid-state battery” of the present disclosure refers to a battery including a component that is in a solid state. For example, the “solid-state battery” of the present disclosure is a stacked-type solid-state battery in which layers are stacked on each other. The layers may each include, for example, a sintered body. The “solid-state battery” of the present disclosure encompasses not only a secondary battery that is repeatedly chargeable and dischargeable but also a primary battery that is merely dischargeable.

Consideration has been given in various ways in relation to improvement in performance of a solid-state battery. The solid-state battery includes a solid-state electrolyte, and therefore typically has superior high-temperature resistance and high safety, compared with a battery including a liquid electrolyte.

A possible way to allow for faster charging and discharging of a secondary battery may be, for example, to use an active material having a greater surface area or to improve an ion conductive property of the active material and the electrolyte. It is generally known that, with an increase in area of an interface between the active material and the electrolyte, where an electrode reactant such as lithium passes, i.e., with an increase in reaction area, a reaction resistance of the electrode reactant decreases and a fast charging property increases. Here, unlike the liquid electrolyte that easily permeates into an electrode, the solid-state electrolyte tends to be in point contact with the active material that is in a solid state. That is, an area of an interface between the solid-state electrolyte and the active material is smaller than an area of an interface between the liquid electrolyte and the active material.

In Japanese Unexamined Patent Application Publication No. 2014-238925, to improve contact between an electrode and a solid-state electrolyte, a polyethylene-oxide-based polymer solid-state electrolyte that is superior in interface formation is mixed with a garnet-type inorganic solid-state electrolyte (Li₇La₃Zr₂O₁₂) having a superior ion conductive property. This secures both the ion conductive property and the interface formation. However, ion conduction in a void, in the electrode, which the inorganic solid-state electrolyte is not able to enter should be dealt with by the polymer solid-state electrolyte, which makes it difficult to improve ion conduction of a lithium ion. To address this issue, the ion conduction is improved by controlling a crystal orientation of a positive electrode active material toward a plane where a lithium ion is easily movable. However, a special crystal orientation control is not only disadvantageous in terms of cost or process, but also decreases a migration velocity of a lithium ion in a crystal. The special crystal orientation control is thus limited in effect of improvement. In addition, the polymer solid-state electrolyte such as a polyethylene-oxide-based polymer is flammable and is therefore inferior in safety.

In “Electrolyte melt infiltration for scalable manufacturing of inorganic all-solid-state lithium-ion batteries”, Yiran Xiao et al., Nature Materials, 20, 984 (2021), to improve contact between an electrode and a solid-state electrolyte, a solid-state electrolyte including Li_{1.9}OHCl_{0.9} is melted at 300° C. and the electrode is impregnated with the molten electrolyte, following which the molten electrolyte is cooled to be solidified. However, impregnability with the molten electrolyte is increased by performing a surface treatment on, for example, an active material, a binder, and a conductive additive by an ALD method. The technique in “Electrolyte melt infiltration for scalable manufacturing of inorganic all-solid-state lithium-ion batteries”, Yiran Xiao et al., Nature Materials, 20, 984 (2021) is thus complicated.

In view of the above-described circumstances, an electrode, for a solid-state battery, having a higher ion conductive property, and a solid-state battery including the same is described below in further detail according to an embodiment of the present disclosure.

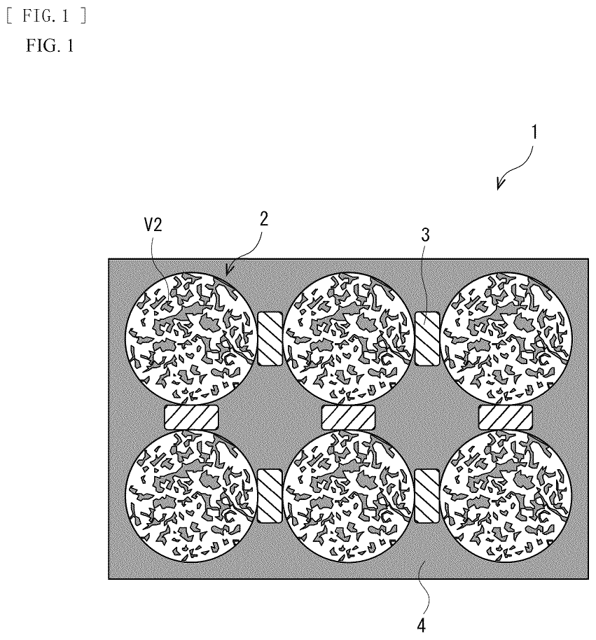

Referring to FIG. 1, a description is given of an electrode 1 for a solid-state battery as an embodiment of the present technology. FIG. 1 is a schematic sectional diagram schematically illustrating an example of a configuration of the electrode 1 for a solid-state battery. The electrode 1 for a solid-state battery includes active material particles 2, a resin 3, and an inorganic solid-state electrolyte 4.

The active material particles 2 each include, without particular limitation, a positive electrode material or a negative electrode material which an electrode reactant such as a lithium ion is insertable into and extractable from. The active material particles 2 each have a porous structure having a pore V2 inside. The pore V2 is not particularly limited in shape. The pore V2 preferably has a dimension of greater than or equal to 10 nm and less than or equal to 500 nm. The active material particles 2 may have a median diameter D50 of greater than or equal to 3 μm and less than or equal to 30 μm.

The resin 3 is a binder so provided in a gap between the active material particles 2 as to couple the active material particles 2 to each other. The resin 3 includes a hydrophilic organic compound. The resin 3 includes an organic compound including a functional group that includes OH at its terminal, which is specifically a hydroxyl group or a carboxyl group, for example. Examples of such an organic compound including the functional group that includes OH at its terminal include a polyacrylic acid resin, a polyvinyl alcohol resin, a cellulose resin, and a phenol resin. Examples of the cellulose resin include carboxymethyl cellulose, ethyl cellulose, methyl cellulose, and hydroxyethyl cellulose. The resin 3 may include a hydrophilic organic compound other than those described above. Specifically, an acrylamide resin, an ester resin, an epoxy resin, or a melamine resin may be used as the resin 3. Examples of the ester resin include methyl methacrylate and vinyl acetate. Examples of the epoxy resin include bisphenol A diglycidyl ether.

The inorganic solid-state electrolyte 4 is meltable at a temperature lower than a volatilization temperature of the resin 3. The pore V2 is impregnated with the inorganic solid-state electrolyte 4. The inorganic solid-state electrolyte 4 is preferably further so provided as to fill the gap between the active material particles 2. The inorganic solid-state electrolyte 4 is meltable at, for example, a temperature of higher than or equal to 200° C. and lower than or equal to 400° C. The inorganic solid-state electrolyte 4 includes a lithium salt including at least one element selected from the group consisting of B (boron), C (carbon), S (sulfur), and Cl (chlorine). Specifically, the inorganic solid-state electrolyte 4 preferably includes at least one of Li₂CO₃, Li₂SO₄, Li₃BO₃, Li₃OCl, or Li₂OHCl as a major component material. The inorganic solid-state electrolyte 4 may include a lithium salt resulting from substituting Cl (chlorine) of Li₃OCl or Li₂OHCl with F (fluorine), Br (bromine), or I (iodine). Specifically, the inorganic solid-state electrolyte 4 may include at least one of Li₃OF, Li₃OBr, Li₃OI, Li₂OHF, Li₂OHBr, or Li₂OHI. The inorganic solid-state electrolyte 4 may include, for example, a sulfide or a halide. Examples of the sulfide include: Li₇PS₆ having an argyrodite structure; a material resulting from substituting a portion thereof, such as Li₆PS₅Cl or Li₆PS₅Br; Li₁₀GeP₂S₁₂ having a LISICON structure; and a material resulting from substituting a portion thereof, such as Li₁₀SiP₂S₁₂ or Li_{9.54}Si_{1.74}P_{1.44}S_{11.7}C_{10.3}. Examples of the halide include: Li₂MCl₄ having an inverse spinel structure where M includes at least one of Mg, Fe, Ni, Zn, Al, In, or Sc; and Li₃MCl₆ having a monoclinic structure where M includes at least one of Al, Ga, In, Sc, or Y. Note that the inorganic solid-state electrolyte 4 may include two or more of the above-described component materials. In addition, the inorganic solid-state electrolyte 4 desirably has no particle interface therein. This is to achieve a superior electrically conductive property of the electrode 1 for a solid-state battery. The inorganic solid-state electrolyte 4 is, for example, an electrolyte resulting from causing a molten lithium salt to permeate the pores V2 of the active material particles 2 and the gap between the active material particles 2 and thereafter crystallizing the molten lithium salt. The molten lithium salt is a salt resulting from melting the above-described lithium salt.

Note that it is desirable that all of the pores V2 and the gap between the active material particles 2 be filled with materials including, without limitation, the inorganic solid-state electrolyte 4 and the resin 3 in the entire electrode 1 for a solid-state battery; however, the electrode 1 for a solid-state battery may have a void in part. Note that a void rate in any section of the electrode 1 for a solid-state battery is preferably less than 5%. The void rate in the section is a proportion of a total area of a void in the section to an area of all of the section. Note that the void rate may be calculated by acquiring an image of any section of the electrode 1 for a solid-state battery by a scanning electron microscope (SEM) and performing a calculation with image processing software. Specifically, for example, ImageJ developed in the public domain is used as the image processing software and an area of all of any sectional image (SEM image) of the electrode 1 for a solid-state battery is determined from the SEM image by “Set Measurement”. Thereafter, a contrast portion corresponding to the void is determined by “Threshold”. “An area of the contrast portion corresponding to the void” is determined by “Limit to Threshold” in “Set Measurement”. The following is determined as the void rate: “area of contrast portion corresponding to void”/“area of all of SEM image”×100 (%).

In addition, a proportion of a weight of the resin 3 to a total weight of the electrode 1 for a solid-state battery excluding the inorganic solid-state electrolyte 4 is preferably less than or equal to 3%.

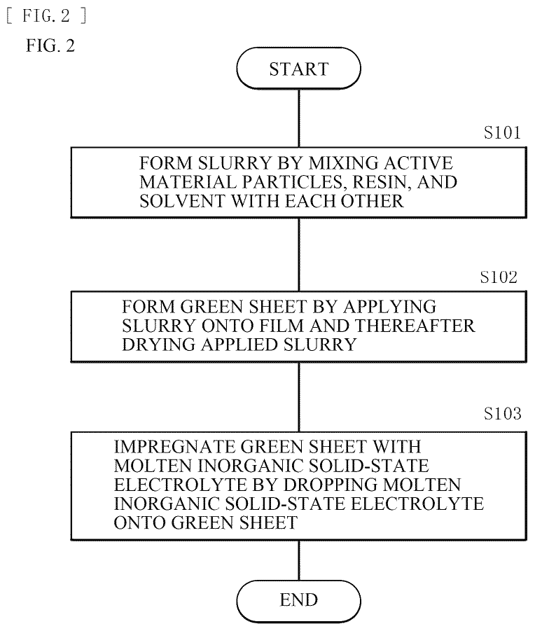

Referring to FIG. 2, a description is given next of an example of a method of manufacturing the electrode 1 for a solid-state battery. FIG. 2 is a flowchart illustrating an example of a manufacturing process of the electrode 1 for a solid-state battery. The electrode 1 for a solid-state battery may be formed by, for example, a green sheet method in which a green sheet is used. One manufacturing method is described below as an example; however, the present disclosure is not limited to the following manufacturing method. Temporal matters such as the order of descriptions below are merely for description convenience, and the present disclosure is not limited thereto.

First, a slurry is formed by mixing active material particles, a resin, and a solvent with each other (step S101). The active material particles each have a porous structure having a pore inside. Upon forming the slurry, any additive such as a conductive additive may be added. Used as the resin is the hydrophilic organic compound including the functional group that includes OH at its terminal.

Thereafter, a green sheet is formed by applying the slurry onto a film and thereafter drying the applied slurry by means of, for example, an oven (step S102). Used as the film onto which the slurry is to be applied may be, for example, a release film including polyethylene terephthalate (PET) or a metal foil.

Thereafter, the fabricated green sheet is impregnated with the inorganic solid-state electrolyte by, for example, dropping, onto the green sheet, the inorganic solid-state electrolyte having been melted at a temperature lower than a volatilization temperature of the resin (step S103). This allows the molten inorganic solid-state electrolyte to permeate, for example, the gap between the active material particles 2 and the pores V2 of the active material particles 2. As the molten inorganic solid-state electrolyte, it is preferable to use a molten lithium salt including at least one of Li₂CO₃, Li₂SO₄, Li₃BO₃, Li₃OCl, or Li₂OHCl. Lastly, the molten inorganic solid-state electrolyte is crystallized by performing a drying process.

The manufacturing of the electrode 1 for a solid-state battery is thus completed.

According to the electrode 1 for a solid-state battery of the embodiment, the pore V2 of each of the active material particles 2 is impregnated with the inorganic solid-state electrolyte 4 that is meltable at the temperature lower than the volatilization temperature of the resin 3 including the hydrophilic organic compound. This makes it possible to increase an area of an interface at which the active material particles 2 and the inorganic solid-state electrolyte 4 are in contact with each other, and to thereby improve an electrode reactant conductive property (a lithium ion conductive property). Accordingly, it is possible to achieve superior performance when the electrode 1 for a solid-state battery is applied to a solid-state battery. For example, it is possible to allow for fast charging or to obtain high output.

In the electrode 1 for a solid-state battery, the resin 3 includes the hydrophilic organic compound. This makes it possible to achieve favorable wettability between the resin 3 and the inorganic solid-state electrolyte 4, for example, without performing a surface treatment on a material such as the active material by an ALD method. Accordingly, it is possible to allow the void rate in the entire electrode 1 for a solid-state battery to be less than 5%. In contrast, for example, when a binder not including the OH group, such as PVDF or PTFE, is used, the binder has less affinity for the inorganic solid-state electrolyte 4 due to an influence of polarity, which causes the void rate to be greater than or equal to 5%. This can decrease the electrode reactant conductive property (the lithium ion conductive property). In the electrode 1 for a solid-state battery, the use of the hydrophilic organic compound improves the wettability between the resin 3 and the inorganic solid-state electrolyte 4, making it possible to achieve a favorable electrically conductive property.

Further, the electrode 1 for a solid-state battery includes the inorganic solid-state electrolyte 4 that is meltable at the temperature lower than the volatilization temperature of the resin 3. This makes it possible to achieve high chemical and thermal stability, as compared with when an electrode includes an organic solid-state electrolyte.

Further, the electrode 1 for a solid-state battery allows the lithium salt included in the inorganic solid-state electrolyte 4 to be melted, allows the active material particles 2 to be impregnated with the molten lithium salt, and allows the molten lithium salt to be thereafter crystallized. This helps to prevent easy generation of an interface between particles of the inorganic solid-state electrolyte 4. Because the interface between the particles of the inorganic solid-state electrolyte 4 decreases an ion conductive property, reducing such an interface between the particles of the inorganic solid-state electrolyte 4 makes it possible to secure a favorable electrically conductive property.

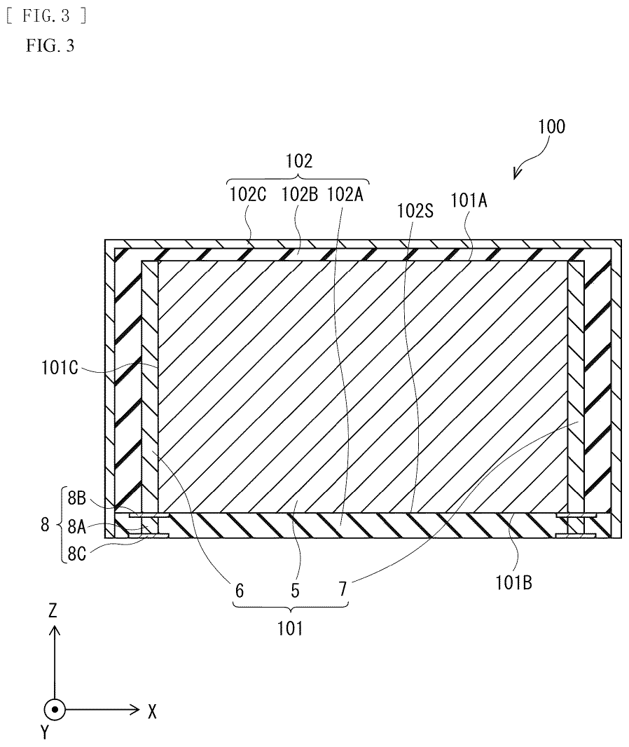

A description is given next of a battery package 100 of another embodiment of the present disclosure. FIG. 3 is a schematic sectional diagram schematically illustrating an overall configuration of the battery package 100. The battery package 100 includes a solid-state battery 101 and a covering part 102 that covers the solid-state battery 101. The solid-state battery 101 is protected from an external environment by the covering part 102. The covering part 102 helps to prevent entry of, for example, water vapor into the solid-state battery 101. In the following, a description is given of the solid-state battery 101, and thereafter of the covering part 102. As used herein, “water vapor” refers to moisture typified by water vapor in the atmosphere, and refers to moisture encompassing not only water vapor in a gas state but also water in a liquid state in some preferred embodiments. The solid-state battery 101 protected against permeation of such moisture is preferably packaged to be suitable for mounting on a substrate, in particular, for mounting on a surface.

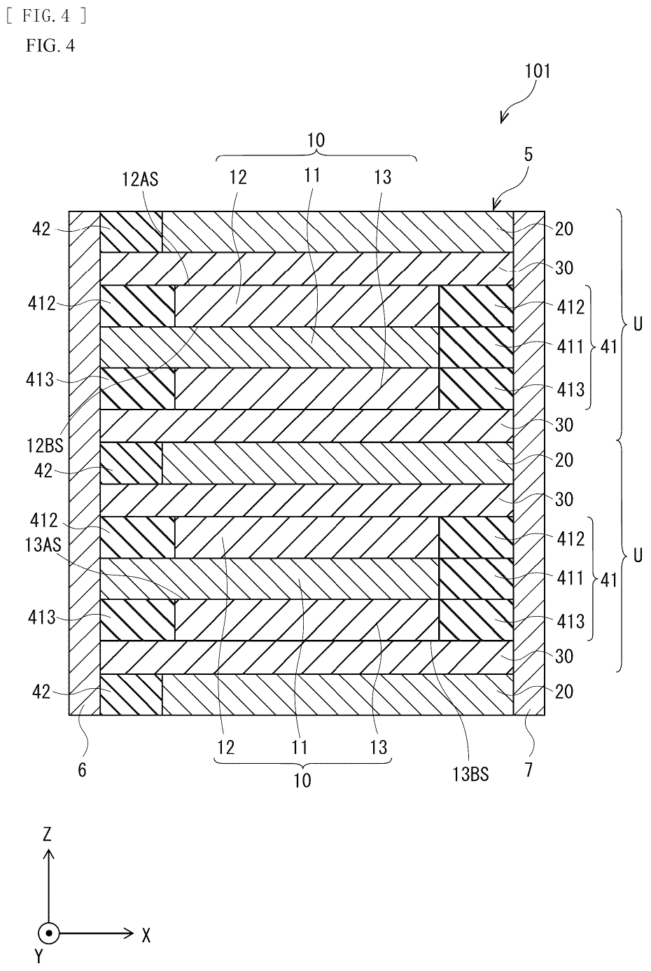

FIG. 4 is a schematic sectional diagram schematically illustrating a configuration of the solid-state battery 101. As illustrated in FIGS. 3 and 4, the solid-state battery 101 includes a stacked body 5, a positive electrode terminal 6, and a negative electrode terminal 7. The positive electrode terminal 6 and the negative electrode terminal 7 are opposed to each other with the stacked body 5 interposed therebetween. As illustrated in FIG. 4, the stacked body 5 includes a positive electrode layer 10, a negative electrode layer 20, and a solid-state electrolyte layer 30 that are stacked on each other in a Z-axis direction. The solid-state electrolyte layer 30 is interposed between the positive electrode layer 10 and the negative electrode layer 20 in the Z-axis direction that is a stacking direction. The solid-state battery 101 specifically has a structure in which multiple units U are stacked on each other in the Z-axis direction. The units U each serve as a single unit and each include the negative electrode layer 20, the solid-state electrolyte layer 30, the positive electrode layer 10, and the solid-state electrolyte layer 30 that are stacked on each other in order. Note that FIG. 4 illustrates the solid-state battery 101 including two units U; however, the solid-state battery 101 is not limited to this example, and may include three or more units U. The solid-state battery 101 may further include margin layers 41 and 42 that are each an electron insulating layer. The margin layer 41 is provided at the same layer level as a portion of the positive electrode layer 10. The margin layer 42 is provided at the same layer level as a portion of the negative electrode layer 20. Each of the layers included in the solid-state battery 101, i.e., each of the positive electrode layer 10, the negative electrode layer 20, the solid-state electrolyte layer 30, and the margin layers 41 and 42 may be, for example, a sintered layer formed by firing. It is preferable that the positive electrode layer 10, the negative electrode layer 20, the solid-state electrolyte layer 30, and the margin layers 41 and 42 be fired together.

The positive electrode layer 10 and the negative electrode layer 20 may each include a conductive additive. The conductive additive that may be included in each of the positive electrode layer 10 and the negative electrode layer 20 may include, for example, at least one selected from the group consisting of, for example: a metal material such as silver, palladium, gold, platinum, copper, or nickel; and carbon. The conductive additive included in the positive electrode layer 10 and the conductive additive included in the negative electrode layer 20 may be of the same kind, or may be of respective kinds different from each other.

In addition, the positive electrode layer 10 and the negative electrode layer 20 may each include a sintering aid. The sintering aid may include, for example, at least one selected from the group consisting of lithium oxide, sodium oxide, potassium oxide, boron oxide, silicon oxide, bismuth oxide, and phosphorous oxide. The sintering aid included in the positive electrode layer 10 and the sintering aid included in the negative electrode layer 20 may be of the same kind, or may be of respective kinds different from each other.

The positive electrode layer 10 is an electrode layer including at least a positive electrode active material. In the solid-state battery 101 illustrated in FIG. 4, the positive electrode layer 10 includes a stacked structure including a positive electrode current collector 11 and a pair of positive electrode active material layers 12 and 13.

The positive electrode current collector 11 is, for example, a metal foil such as an aluminum foil. Alternatively, the positive electrode current collector 11 may be a sintered body. This is to allow the solid-state battery 101 to be formed by integral firing, or to reduce an internal resistance of the positive electrode current collector 11. When the positive electrode current collector 11 is the sintered body, the positive electrode current collector 11 may include a conductive additive and a sintering aid. The conductive additive included in the positive electrode current collector 11 may be of the same kind as the conductive additive included in, for example, the positive electrode active material layers 12 and 13. The sintering aid included in the positive electrode current collector 11 may be of the same kind as the sintering aid included in, for example, the positive electrode active material layers 12 and 13. Note that FIG. 4 illustrates, as an example, an embodiment where the positive electrode layer 10 includes the positive electrode current collector 11; however, the positive electrode current collector 11 is not an essential component. In some embodiments, the positive electrode layer 10 may include no positive electrode current collector 11 and may include either the positive electrode active material layer 12 or the positive electrode active material layer 13.

The positive electrode active material layers 12 and 13 each include the positive electrode active material as a major component. The positive electrode active material layer 12 is provided on an upper surface of the positive electrode current collector 11, and the positive electrode active material layer 13 is provided on a lower surface of the positive electrode current collector 11. The configuration of the electrode 1 for a solid-state battery described in the first embodiment above is adoptable for each of the positive electrode active material layers 12 and 13.

The positive electrode active material included in each of the positive electrode active material layers 12 and 13 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte. In other words, ion conduction occurs between the positive electrode layer 10 and the negative electrode layer 20 via the solid-state electrolyte. The insertion and extraction of the ion into and from the positive electrode active material involve reduction and oxidation of the positive electrode active material. An electron and a hole for such reduction and oxidation reactions are respectively supplied from the external circuit to the positive electrode terminal 6 and the negative electrode terminal 7, and further respectively supplied to the positive electrode layer 10 and the negative electrode layer 20. This allows charging and discharging to proceed. The positive electrode active material layers 12 and 13 are each, for example, a layer which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. That is, the solid-state battery 101 is preferably an all-solid-state secondary battery that is to be charged and discharged by the above-described ion moving between the positive electrode layer 10 and the negative electrode layer 20 via the solid-state electrolyte.

The positive electrode active material included in the positive electrode layer 10 includes, for example, at least one selected from the group consisting of, for example, a lithium-containing phosphoric acid compound having a NASICON structure, a lithium-containing phosphoric acid compound having an olivine structure, a lithium-containing layered oxide, and a lithium-containing oxide having a spinel structure. Examples of the lithium-containing phosphoric acid compound having the NASICON structure include Li₃V₂(PO₄)₃. Examples of the lithium-containing phosphoric acid compound having the olivine structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.8}Ni_{0.15}Al_{0.05}O₂. Examples of the lithium-containing oxide having the spinel structure include LiMn₂O₄ and LiNi_{0.5}Mn_{1.5}O₄.

The positive electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, a sodium-containing layered oxide, and a sodium-containing oxide having a spinel structure.

The negative electrode layer 20 is an electrode layer including at least a negative electrode active material. The configuration of the electrode 1 for a solid-state battery described in the first embodiment above is adoptable for the negative electrode layer 20. The negative electrode layer 20 may include a negative electrode current collector. The negative electrode current collector is, for example, a metal foil such as a copper foil. Alternatively, the negative electrode current collector may be a sintered body. This is to allow the solid-state battery 101 to be formed by integral firing, or to reduce an internal resistance of the negative electrode current collector. When the negative electrode current collector is the sintered body, the negative electrode current collector may include a conductive additive and a sintering aid.

As with the positive electrode active material included in the positive electrode layer 10, the negative electrode active material included in the negative electrode layer 20 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte layer 30. In other words, ion conduction occurs between the positive electrode layer 10 and the negative electrode layer 20 via the solid-state electrolyte layer 30. The insertion and extraction of the ion into and from the negative electrode active material involve oxidation or reduction of the negative electrode active material. An electron or a hole for such an oxidation or reduction reaction is supplied from the external circuit to the positive electrode terminal 6 or the negative electrode terminal 7, and further supplied to the positive electrode layer 10 or the negative electrode layer 20, which allows charging and discharging to proceed. The negative electrode active material is, for example, a material which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. The negative electrode active material included in the negative electrode layer 20 includes, for example, at least one selected from the group consisting of, for example: an oxide including at least one element selected from the group consisting of Ti, Si, Sn, Cr, Fe, Nb, and Mo; a graphite-lithium compound; a lithium alloy; a lithium-containing phosphoric acid compound having a NASICON structure; a lithium-containing phosphoric acid compound having an olivine structure; and a lithium-containing oxide having a spinel structure. Examples of the lithium alloy include Li—Al. Examples of the lithium-containing phosphoric acid compound having the NASICON structure include Li₃V₂(PO₄)₃ and LiTi₂(PO₄)₃. Examples of the lithium-containing phosphoric acid compound having the olivine structure include Li₃Fe₂(PO₄)₃ and LiCuPO₄. Examples of the lithium-containing oxide having the spinel structure include Li₄Ti₅O₁₂.

The negative electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, and a sodium-containing oxide having a spinel structure.

The solid-state electrolyte included in the solid-state electrolyte layer 30 is, for example, a material conductive of an ion such as a lithium ion or a sodium ion. In particular, the solid-state electrolyte forming a battery configuration unit in a solid-state battery forms a layer conductive of, for example, a lithium ion between the positive electrode layer 10 and the negative electrode layer 20. Specific examples of the solid-state electrolyte include a lithium-containing phosphoric acid compound having a NASICON structure, an oxide having a perovskite structure, and an oxide having a garnet structure or a garnet-like structure. The lithium-containing phosphoric acid compound having the NASICON structure is, for example, LiₓM_{y}(PO₄)₃ (where 1≤x≤2, 1≤y≤2, and M is at least one selected from the group consisting of Ti, Ge, Al, Ga, and Zr). Examples of the lithium-containing phosphoric acid compound having the NASICON structure include Li_{1.2}Al_{0.2}Ti_{1.8}(PO₄)₃. Examples of the oxide having the perovskite structure include La_{0.55}Li_{0.35}TiO₃. Examples of the oxide having the garnet structure or the garnet-like structure include Li₇La₃Zr₂O₁₂. Examples of the solid-state electrolyte conductive of a sodium ion include a sodium-containing phosphoric acid compound having a NASICON structure, an oxide having a perovskite structure, and an oxide having a garnet structure or a garnet-like structure. Examples of the sodium-containing phosphoric acid compound having the NASICON structure include NaₓM_{y}(PO₄)₃ (where 1≤x≤2, 1≤y≤2, and M is at least one selected from the group consisting of Ti, Ge, Al, Ga, and Zr).

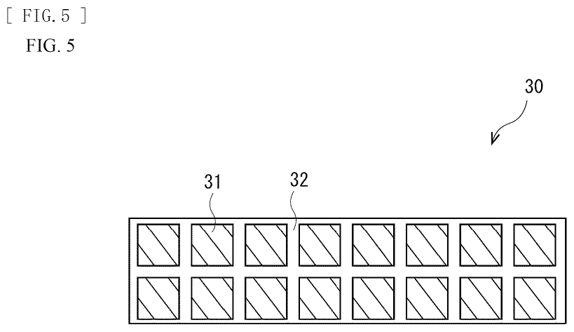

For example, as illustrated in FIG. 5, the solid-state electrolyte layer 30 may be a mixture that includes a first solid-state electrolyte 31 having a perovskite structure and a second solid-state electrolyte 32 having an antiperovskite structure. FIG. 5 is a schematic sectional diagram schematically illustrating an example of a configuration of the solid-state electrolyte layer 30. Combining the first solid-state electrolyte 31 having the perovskite structure and the second solid-state electrolyte 32 having the antiperovskite structure allows the solid-state electrolyte layer 30 to be in a favorable lattice-matched state. Specifically, the first solid-state electrolyte 31 includes electrolyte particles, and the second solid-state electrolyte 32 fills a gap between the pieces of the first solid-state electrolyte 31 in particle form. In the solid-state electrolyte layer 30, for example, the first solid-state electrolyte 31 is dispersed in and surrounded by the second solid-state electrolyte 32. Accordingly, the second solid-state electrolyte 32 includes little grain boundaries. Suppressing formation of the grain boundaries in the second solid-state electrolyte 32 allows the solid-state electrolyte layer 30 to have a high ion conductivity, making it possible for the solid-state battery 101 to allow for, for example, fast charging and high output.

It is desirable that the first solid-state electrolyte 31 having the perovskite structure and the second solid-state electrolyte 32 having the antiperovskite structure have respective lattice constants of crystals that are similar to each other. The perovskite structure and the antiperovskite structure are reversed structures in terms of arrangement of cations having positive charge and anions having negative charge. Therefore, if the lattice constant of the perovskite structure and the lattice constant of the antiperovskite structure are similar to each other, positive charge and negative charge are to be located adjacent to each other when the perovskite structure and the antiperovskite structure are brought into contact with each other. This allows for formation of an ionic bond in a lattice-matched state with less misalignment in ion configuration, providing a very clean interface between the first solid-state electrolyte 31 and the second solid-state electrolyte 32. As used herein, the “clean interface” refers to an interface in an epitaxial state (a lattice-matched state) with a markedly small number of structural defects. Further, the “lattice-matched state” refers to, for example, a state where a ratio of the lattice constant of the antiperovskite structure to the lattice constant of the perovskite structure is greater than or equal to 0.9 and less than or equal to 1.1. In particular, the ratio of the lattice constant of the antiperovskite structure to the lattice constant of the perovskite structure is desirably greater than or equal to 0.95 and less than or equal to 1.05.

Used as each of the first solid-state electrolyte 31 and the second solid-state electrolyte 32 may be a solid-state electrolyte having a lattice constant that is an integer multiple of a value of greater than or equal to 3.8 Å and less than or equal to 4.1 Å. Specifically, the first solid-state electrolyte 31 is preferably Li_{0.33}La_{0.56}TiO₃, and the second solid-state electrolyte 32 is preferably Li₃OCl or Li₂(OH)Cl. The lattice constant of Li_{0.33}La_{0.56}TiO₃ is 3.92 Å. The lattice constant of Li₃OCl and the lattice constant of Li₂(OH)Cl are each 3.91 Å.

The solid-state electrolyte layer 30 may include a sintering aid. The sintering aid that may be included in the solid-state electrolyte layer 30 may be selected from, for example, materials similar to the sintering aids that may be included in the positive electrode layer 10 and the negative electrode layer 20.

The positive electrode terminal 6 and the negative electrode terminal 7 are each an external coupling terminal adapted to couple the stacked body 5 and an external device to each other. The positive electrode terminal 6 and the negative electrode terminal 7 are each preferably provided as an end face electrode on a side surface of the stacked body 5. That is, the positive electrode terminal 6 and the negative electrode terminal 7 each extend along the Z-axis direction that is the stacking direction of the stacked body 5. In FIG. 4, the positive electrode terminal 6 and the negative electrode terminal 7 are opposed to each other in an X-axis direction. The positive electrode terminal 6 is electrically coupled to an end face of the positive electrode current collector 11 of the positive electrode layer 10, as illustrated in FIG. 4. The negative electrode terminal 7 is electrically coupled to an end face of the negative electrode layer 20. The positive electrode terminal 6 and the negative electrode terminal 7 each preferably include a material having a high electrical conductivity. The positive electrode terminal 6 and the negative electrode terminal 7 may each include, for example, at least one material selected from the group consisting of gold, silver, platinum, aluminum, tin, nickel, copper, manganese, cobalt, iron, titanium, and chromium. However, the material included in each of the positive electrode terminal 6 and the negative electrode terminal 7 is not limited to the above-described materials.

The margin layer 41 includes margin parts 411 to 413. The margin part 411 is provided at the same layer level as the positive electrode current collector 11, between the positive electrode current collector 11 and the negative electrode terminal 7. The margin part 412 is provided at the same layer level as the positive electrode active material layer 12, between the positive electrode active material layer 12 and each of the positive electrode terminal 6 and the negative electrode terminal 7. The margin part 413 is provided at the same layer level as the positive electrode active material layer 13, between the positive electrode active material layer 13 and each of the positive electrode terminal 6 and the negative electrode terminal 7. The margin layer 42 is provided at the same layer level as the negative electrode layer 20, between the negative electrode layer 20 and the positive electrode terminal 6.

The margin parts 411 to 413 of the margin layer 41 and the margin layer 42 each include, for example, a material having an electron insulating property. The material having the electron insulating property is hereinafter simply referred to as an “insulating material”.

Examples of the insulating material include a glass material and a ceramic material. The glass material may include, without limitation, at least one selected from the group consisting of soda-lime glass, soda potash glass, boric-acid-salt-based glass, borosilicic-acid-salt-based glass, barium-borosilicate-based glass, zinc-borate-based glass, barium-borate-based glass, bismuth-borosilicate-based glass, bismuth-zinc-borate-based glass, bismuth-silicate-based glass, phosphoric-acid-salt-based glass, aluminophosphate-based glass, and zinc-phosphate-based glass, for example. The ceramic material may include, without limitation, at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃), for example.

The insulating material included in each of the margin layers 41 and 42 may include a solid-state electrolyte. In such a case, the solid-state electrolyte included in the insulating material is preferably the same material as the solid-state electrolyte included in the solid-state electrolyte layer 30. A reason for this is that such a configuration makes it possible to further improve a binding property between each of the margin layers 41 and 42 and the solid-state electrolyte layer 30.

As illustrated in FIG. 3, the covering part 102 of the battery package 100 includes a support substrate 102A, an insulating covering film 102B, and an inorganic covering film 102C. In the battery package 100, the entire solid-state battery 101 is surrounded by the covering part 102. In other words, the covering part 102 is so provided as to prevent the solid-state battery 101 from being exposed to an outside.

The support substrate 102A is a plate-shaped member that supports the solid-state battery 101. The support substrate 102A includes a surface 102S opposed to a bottom surface 101B that is a major surface of the solid-state battery 101. The support substrate 102A may be a resin substrate, or may be a ceramic substrate. In some preferred embodiments, the support substrate 102A is the ceramic substrate. The support substrate 102A includes ceramics as a major component. The support substrate 102A that is the ceramic substrate is superior in preventing permeation of water vapor and in heat resistance, which is preferable. The ceramic substrate may be obtained by, for example, firing a green sheet stacked body. Specifically, the ceramic substrate may be a low-temperature co-fired ceramic (LTCC) substrate, or may be a high-temperature co-fired ceramic (HTCC) substrate. Although the following ranges are mere examples, the support substrate 102A has a thickness of greater than or equal to 20 μm and less than or equal to 1000 μm, and may have a thickness of greater than or equal to 100 μm and less than or equal to 300 μm, for example.

The insulating covering film 102B is so provided as to cover at least a top surface 101A and a side surface 101C of the solid-state battery 101. As illustrated in FIG. 3, the entire solid-state battery 101 provided on the support substrate 102A is surrounded by the insulating covering film 102B. In some preferred embodiments, the insulating covering film 102B is so provided as to cover all of the top surface 101A and the side surface 101C of the solid-state battery 101. Of the two major surfaces included in the solid-state battery 101, a surface positioned relatively on an upper side is the top surface 101A. Of the two major surfaces included in the solid-state battery 101, a surface positioned relatively on a lower side is the bottom surface 101B. Accordingly, the top surface 101A is the major surface positioned on an opposite side to the support substrate 102A. It is therefore preferable that the insulating covering film 102B cover all of the surfaces of the solid-state battery 101, except for the bottom surface 101B. The insulating covering film 102B includes, for example, a resin material that is able to block water vapor. The insulating covering film 102B forms a favorable water vapor barrier together with the inorganic covering film 102C. Examples of a material included in the insulating covering film 102B include an epoxy-based resin, a silicone-based resin, and a liquid crystal polymer. Although the following ranges are mere examples, the insulating covering film 102B has a thickness of greater than or equal to 30 μm and less than or equal to 1000 μm, and may have a thickness of greater than or equal to 50 μm and less than or equal to 300 μm, for example.

The inorganic covering film 102C is so provided as to cover the insulating covering film 102B. The inorganic covering film 102C is positioned on the insulating covering film 102B, and therefore has a form that surrounds, together with the insulating covering film 102B, the entire solid-state battery 101 on the support substrate 102A. A material included in the inorganic covering film 102C is not particularly limited as long as the material is an inorganic material. The inorganic covering film 102C may include, for example, a metal, glass, oxide ceramics, or a mixture thereof. In some preferred embodiments, the inorganic covering film 102C includes a metal component. That is, the inorganic covering film 102C may be a thin metal film. Although the following ranges are mere examples, the inorganic covering film 102C has a thickness of greater than or equal to 0.1 μm and less than or equal to 100 μm, and may have a thickness of greater than or equal to 1 μm and less than or equal to 50 μm, for example. The inorganic covering film 102C may be a dry plating film. As used herein, the dry plating film refers to a film that is obtainable by a vapor deposition method such as a physical vapor deposition (PVD) method or a chemical vapor deposition (CVD) method, and is a thin film having a markedly small thickness in nanometer or micrometer order. The dry plating film that is a thin film contributes to a decrease in size and thickness of the battery package 100. The dry plating film preferably includes, for example, at least one selected from the group consisting of aluminum (Al), nickel (Ni), palladium (Pd), silver (Ag), tin (Sn), gold (Au), copper (Cu), titanium (Ti), platinum (Pt), silicon (Si), and stainless steel. The dry plating film including such a component is chemically and thermally stable, and is therefore superior in a property such as chemical resistance, weather resistance, or heat resistance. This helps to provide the solid-state battery 101 with further improved long-term reliability.

In the battery package 100 illustrated in FIG. 3, the support substrate 102A is configured as a terminal substrate on which a substrate wiring 8 is provided. The substrate wiring 8 includes an external terminal adapted to couple the solid-state battery 101 and an external device to each other. The substrate wiring 8 of the support substrate 102A serving as the terminal substrate is not particularly limited, and may be any wiring that allows for electrical coupling between an upper surface and a lower surface of the support substrate 102A. In FIG. 3, the support substrate 102A is provided with the substrate wiring 8 including a via 8A and a pair of lands 8B and 8C. The land 8B is exposed at the upper surface of the support substrate 102A, and is electrically coupled to the positive electrode terminal 6 or the negative electrode terminal 7. The land 8C is exposed at the lower surface of the support substrate 102A. The via 8A so runs through the support substrate 102A as to couple the land 8B and the land 8C to each other.

A brief description is given next of a method of manufacturing the battery package 100 of the present disclosure. The battery package 100 is fabricable by, for example, a process of manufacturing the solid-state battery 101 and a process of packaging the solid-state battery 101.

In manufacturing the stacked body 5 of the solid-state battery 101, used may be a printing method such as a screen printing method, a green sheet method in which a green sheet is used, or a combined method thereof.

A manufacturing method is described below as an example; however, the present disclosure is not limited to the following manufacturing method. Temporal matters such as the order of descriptions below are merely for description convenience, and the present disclosure is not limited thereto.

First, the positive electrode layer 10 is fabricated in accordance with the procedure in the first embodiment described above. Specifically, the positive electrode current collector 11 is prepared, following which positive electrode active material particles, a resin, and a solvent are mixed with each other to form a positive electrode slurry. Thereafter, the positive electrode slurry is applied to both sides of the positive electrode current collector 11, following which the applied positive electrode slurry is dried to thereby form a green sheet for a positive electrode. Lastly, the green sheet for a positive electrode is impregnated with a molten solid-state electrolyte for a positive electrode by, for example, dropping the molten solid-state electrolyte for a positive electrode onto the green sheet. As the molten solid-state electrolyte for a positive electrode, it is preferable to use a molten lithium salt including at least one of Li₂CO₃, Li₂SO₄, Li₃BO₃, Li₃OCl, or Li₂OHCl. In such a manner, the positive electrode layer 10 is obtained.

Thereafter, the negative electrode layer 20 is fabricated in accordance with the procedure in the first embodiment described above. Specifically, negative electrode active material particles, a resin, and a solvent are mixed with each other to form a negative electrode slurry. Thereafter, the negative electrode slurry is applied onto a film, following which the applied negative electrode slurry is dried to form a green sheet for a negative electrode. Lastly, the green sheet for a negative electrode is impregnated with a molten solid-state electrolyte for a negative electrode by, for example, dropping the molten solid-state electrolyte for a negative electrode onto the green sheet. As the molten solid-state electrolyte for a negative electrode, it is preferable to use a molten lithium salt including at least one of Li₂CO₃, Li₂SO₄, Li₃BO₃, Li₃OCl, or Li₂OHCl. In such a manner, the negative electrode layer 20 is obtained.

Thereafter, a solid-state electrolyte sintered body is fabricated as follows. Specifically, first, oxide solid-state electrolyte powder and an organic binder are kneaded with each other to fabricate a kneaded powder body. Li_{0.33}La_{0.56}TiO₃ may be used as the oxide solid-state electrolyte powder. A polybutyral binder may be used as the organic binder. Thereafter, the kneaded powder body is compression-molded by, for example, a cold isostatic press (CIP) method to thereby fabricate a compression-molded body. Further, the compression-molded body is fired in an air atmosphere at a predetermined temperature for a predetermined period of time to thereby obtain the solid-state electrolyte sintered body. The firing condition is set to, for example, 1300° C. and 10 hours.

Further, materials including, without limitation, an insulating material, a binder, an organic binder, a solvent, and any additive are mixed with each other to fabricate an insulating paste.

Thereafter, the positive electrode layer 10, the solid-state electrolyte sintered body, the negative electrode layer 20, and the solid-state electrolyte sintered body are stacked on each other to fabricate a stacked structure. The stacked structure corresponds to one unit U illustrated in FIG. 4. In fabricating the stacked structure, the insulating paste is applied to a location where the margin layers 41 and 42 are to be formed. The stacked structure is impregnated with a molten solid-state electrolyte for a solid-state electrolyte layer by, for example, dropping the molten solid-state electrolyte for a solid-state electrolyte layer onto the stacked structure, following which the resultant is dried. In such a manner, the solid-state electrolyte sintered body is impregnated with the solid-state electrolyte. As a result, the solid-state electrolyte layer 30 is obtained. As the molten solid-state electrolyte for a solid-state electrolyte layer, it is preferable to use a molten lithium salt including at least one of Li₂CO₃, Li₂SO₄, Li₃BO₃, Li₃OCl, or Li₂OHCl. The dried stacked structure is compressed by a method such as a cold isostatic press (CIP) method to compression-bond the positive electrode layer 10, the solid-state electrolyte layer 30, the negative electrode layer 20, and the solid-state electrolyte layer 30 to each other. Lastly, the stacked structure is heated in a nitrogen atmosphere at a temperature lower than 800° C. to thereby obtain the stacked body 5.

Thereafter, an electrically conductive paste is applied to a side surface, of the stacked body 5 having been subjected to the heating process, where a portion of the positive electrode layer 10 is exposed. It is thereby possible to form the positive electrode terminal 6. In a similar manner, the electrically conductive paste is applied to a side surface, of the stacked body 5 having been subjected to the heating process, where a portion of the negative electrode layer 20 is exposed. It is thereby possible to form the negative electrode terminal 7. Note that the positive electrode terminal 6 and the negative electrode terminal 7 do not necessarily have to be formed on the stacked body 5 having already been subjected to the heating process. The positive electrode terminal 6 and the negative electrode terminal 7 may be formed on the stacked structure before the heating process and may be heated together with the stacked structure.

It is thereby possible to obtain the solid-state battery 101.

First, the support substrate 102A is prepared. The support substrate 102A may be obtained by, for example, stacking green sheets on each other and firing the stacked green sheets. The support substrate 102A may be prepared in a similar manner to, for example, formation of an LTCC substrate. The substrate wiring 8 including the via 8A and the lands 8B and 8C is formed in advance on the support substrate 102A. Specifically, the via 8A and the lands 8B and 8C are formed by, for example, forming a hole in a green sheet by means of, for example, a punch press or a carbon dioxide laser, and thereafter filling the formed hole with an electrically conductive paste material or performing a printing process, for example. Thereafter, a predetermined number of such green sheets are stacked on each other and thermocompression-bonded to each other to form a green sheet stacked body. The green sheet stacked body is fired. It is thereby possible to obtain the support substrate 102A on which the substrate wiring 8 is formed. Note that the substrate wiring 8 may be formed after firing the green sheet stacked body.

After the support substrate 102A is prepared as described above, the solid-state battery 101 is disposed on the support substrate 102A. At this time, the solid-state battery 101 is so disposed on the support substrate 102A that the substrate wiring 8 of the support substrate 102A and each of the positive electrode terminal 6 and the negative electrode terminal 7 of the solid-state battery 101 are electrically coupled to each other. Note that an electrically conductive paste including a material such as silver may be applied onto the substrate wiring 8 of the support substrate 102A, and the applied electrically conductive paste and each of the positive electrode terminal 6 and the negative electrode terminal 7 may be electrically coupled to each other.

Thereafter, the insulating covering film 102B is so formed as to cover the entire solid-state battery 101 on the support substrate 102A. When the insulating covering film 102B includes a resin material, the resin material is so applied as to cover the side surface 101C and the top surface 101A of the solid-state battery 101, following which the applied resin material is cured to thereby form the insulating covering film 102B. For example, the insulating covering film 102B may be shaped by applying pressure to the resin material with use of a mold having a predetermined shape. Note that the shaping of the insulating covering film 102B does not necessarily have to be performed by molding with use of the mold, and may be performed by another method such as polishing processing, laser processing, or a chemical process.

Thereafter, the inorganic covering film 102C is so formed as to cover the entire insulating covering film 102B. Specifically, the inorganic covering film 102C may be formed by performing, for example, dry plating.

Through the above-described processes, it is possible to obtain the battery package 100 in which the entire solid-state battery 101 placed on the support substrate 102A is covered with the insulating covering film 102B and the inorganic covering film 102C.

According to the battery package 100 including the solid-state battery 101 of the embodiment, the stacked body 5 of the solid-state battery 101 includes the positive electrode layer 10 and the negative electrode layer 20 in each of which the configuration of the electrode 1 for a solid-state battery described in the first embodiment above is adopted. Thus, the positive electrode layer 10 and the negative electrode layer 20 make it possible to increase an area of an interface at which the active material particles 2 and the inorganic solid-state electrolyte 4 are in contact with each other, and to thereby improve an electrode reactant conductive property (a lithium ion conductive property). Accordingly, it is possible for the solid-state battery 101 to achieve superior performance. For example, it is possible for the solid-state battery 101 to allow for fast charging or to obtain high output.

A description is given next of applications (application examples) of the battery package including the solid-state battery described above.

The applications of the battery package are not particularly limited as long as they are, for example, machines, equipment, instruments, apparatuses, or systems (an assembly of a plurality of pieces of equipment, for example) in which the solid-state battery is usable mainly as a driving power source, an electric power storage source for electric power accumulation, or any other source. The battery package used as a power source may serve as a main power source or an auxiliary power source. The main power source is preferentially used regardless of the presence of any other power source. The auxiliary power source may be used in place of the main power source, or may be switched from the main power source on an as-needed basis. When the battery package is used as the auxiliary power source, the kind of the main power source is not limited to a power source including the solid-state battery.

Specific examples of the applications of the battery package include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use in which electric power is accumulated for a situation such as emergency. Note that the battery package may be applied to a battery module including a plurality of battery packages.

The battery module is effectively applied to relatively large-sized equipment, etc., including an electric vehicle, an electric power storage system, and an electric power tool. The electric vehicle is a vehicle that operates (travels) with the battery module as a driving power source, and may be an automobile that is additionally provided with a driving source other than the battery package including the solid-state battery. A hybrid automobile is an example of such an automobile. The electric vehicle is a vehicle that operates (travels) with the battery module as a driving power source, and may be an automobile that is additionally provided with a driving source other than the battery package including the solid-state battery, such as a hybrid automobile. The electric power storage system is a system in which the battery package is used as an electric power storage source. The electric power storage system for home use accumulates electric power in the battery package serving as an electric power storage source, and the accumulated electric power may thus be utilized for using, for example, home appliances.

A description is given of Examples of the present disclosure according to an embodiment.

### Example 1

A solid-state battery for evaluation was fabricated, following which the solid-state battery for evaluation was evaluated for its battery characteristic as described below. The solid-state battery for evaluation included: an electrode for a solid-state battery of the present disclosure illustrated in FIG. 1, i.e., an electrode for evaluation; a reference electrode as a counter electrode with respect to the electrode for a solid-state battery; and a solid-state electrolyte layer provided between the electrode for a solid-state battery and the reference electrode. Note that the electrode for a solid-state battery had a stacked structure in which a metal foil as a current collector and active material layers were stacked on each other. The active material layers were provided on respective opposite sides of the metal foil. The reference electrode included a stacked structure body in which a lithium metal foil and an indium metal foil were stacked on each other.

### (Fabrication of Electrode for Solid-State Battery)

First, a copper foil having a thickness of 15 μm was prepared as the current collector. Thereafter, the following materials were mixed with each other to obtain a mixture: Li₄Ti₅O₁₂ having a porous structure having an average pore diameter value of 350 nm, as the active material; a hydrophilic carboxymethyl cellulose resin (CMC) as the binder; and a conductive additive in which carbon black, acetylene black, and Ketjen black were mixed with each other. A mixture ratio between the active material, the binder, and the conductive additive was set to 90:5:5. Thereafter, the mixture was put into NMP (N-methyl-2-pyrrolidone) as an organic solvent, following which the organic solvent into which the mixture had been put was stirred to thereby prepare a slurry in paste form. The stirring was performed by means of a hybrid mixer at a rotation speed of 2000 rpm for 3 minutes. Thereafter, the slurry was applied to a predetermined region of each of the opposite sides of the current collector by means of a coating apparatus, following which the applied slurry was dried to thereby form a green sheet for a positive electrode on each of the opposite sides of the current collector.

### (Fabrication of Reference Electrode)

A Li metal foil having a thickness of 50 μm and an In metal foil having a thickness of 200 μm were stacked on each other, following which the Li metal foil and the In metal foil were compression-bonded to each other by being pressed at a pressure of 1 MPa to fabricate the reference electrode. In this Example, the reference electrode was so disposed that the In metal foil was opposed to the electrode for a solid-state battery with the solid-state electrolyte layer interposed therebetween.

### (Fabrication of Compression-Molded Body of Solid-State Electrolyte)

Li_{0.33}La_{0.56}TiO₃ as solid-state electrolyte powder and Li₂OHCl as solid-state electrolyte powder were mixed with each other and thereafter kneaded to form a kneaded powder body. A mixture ratio between Li_{0.33}La_{0.56}TiO₃ and Li₂OHCl was 25:75. Thereafter, the kneaded powder body was compression-molded by a cold isostatic press (CIP) method at a pressure of 200 MPa to fabricate a compression-molded body.

### (Fabrication of Stacked Body)

Thereafter, the electrode for a solid-state battery and the compression-molded body of the solid-state electrolyte each fabricated as described above were stacked on each other, following which the resultant was heated in a nitrogen atmosphere at a temperature of 270° C. for 1 hour. In such a manner, a joined sintered body of the positive electrode and the solid-state electrolyte was obtained. Thereafter, the joined sintered body of the positive electrode and the solid-state electrolyte and the reference electrode were stacked on each other, following which the joined sintered body of the positive electrode and the solid-state electrolyte and the reference electrode were compression-bonded to each other by being pressed to thereby obtain a stacked body.

Thereafter, the electrically conductive paste was applied to a side surface, of the stacked body, where a portion of the electrode for a solid-state battery was exposed, to thereby form an electrode terminal. Similarly, the electrically conductive paste was applied to a side surface where a portion of the reference electrode was exposed, to thereby form a reference electrode terminal.

In such a manner, the solid-state battery for evaluation was obtained. Note that the particles of Li₄Ti₅O₁₂ having the porous structure used as the active material had a median diameter D50 of 8 μm.

### (Battery Characteristic Evaluation)

Evaluation of the solid-state battery for its battery characteristic revealed the result presented in Table 1. Here, the solid-state battery was evaluated for a cycle capacity retention rate [%] after 100 cycles of charging and discharging performed in an environment at a temperature of 90° C. Specifically, the solid-state battery of Example 1 was charged and discharged as follows. First, the solid-state battery was charged with a constant current of 0.5 mA until a battery voltage reached a specified charging voltage indicated in Table 1, and was charged with a constant voltage that was the specified charging voltage until a battery current reached 0.05 mA. Thereafter, the solid-state battery was discharged with a constant current of 0.5 mA until the battery voltage reached a specified discharging voltage. The above-described combination of charging and discharging was regarded as one cycle, and the solid-state battery was charged and discharged repeatedly in such a manner for 100 cycles. A ratio of a 100th-cycle discharge capacity to a first-cycle discharge capacity was calculated, and the resulting numerical value was regarded as the cycle capacity retention rate [%] after 100 cycles of charging and discharging.

### Example 2

A solid-state battery for evaluation was fabricated in a manner similar to that in Example 1, except that an aluminum foil having a thickness of 15 μm was used as the current collector of the electrode for a solid-state battery, and a lithium-nickel-cobalt-aluminum oxide (NCA having an average pore diameter value of 30 nm) having a porous structure was used as the active material as indicated in Table 1, following which the solid-state battery for evaluation was evaluated for its battery characteristic in a manner similar to that in Example 1. The result of the evaluation is also presented in Table 1. Note that the particles of NCA having the porous structure used as the active material had a median diameter D50 of 18 μm.

### Comparative Example 1

A solid-state battery for evaluation was fabricated in a manner similar to that in Example 1, except that hydrophobic PVDF (polyvinylidene difluoride) was used as the binder of the electrode for a solid-state battery, following which the solid-state battery for evaluation was evaluated for its battery characteristic in a manner similar to that in Example 1. The result of the evaluation is also presented in Table 1.

### Comparative Example 2

A solid-state battery for evaluation was fabricated in a manner similar to that in Example 1, except that Li₇La₃Zr₂O₁₂ having a melting point of 1550° C. was used as the solid-state electrolyte and that hydrophobic PVDF (polyvinylidene difluoride) was used as the binder of the electrode for a solid-state battery, following which the solid-state battery for evaluation was evaluated for its battery characteristic in a manner similar to that in Example 1. The result of the evaluation is also presented in Table 1. Note that the particles of Li₄Ti₅O₁₂ having the porous structure used as the active material had a median diameter D50 of 3.91 μm.

TABLE 1

| | Electrode for evaluation | | | | | | Capacity retention |
|---|---|---|---|---|---|---|---|
| | (Positive electrode) | | Reference electrode | | | Void rate | rate after 100 cycles |
| | Active material | Binder | (Negative electrode) | Specified voltage | Solid-state electrolyte | [%] | [%] |
| Example 1 | Porous Li₄Ti₅O₁₂ | CMC | Li—In | 1.38 V (Charging) | Li₂(OH)Cl | 0.9 | 93 |
| | (D₅₀ = 8 μm) | | | 0.38 V (Discharging) | (Melting point 292° C.) | | |
| Example 2 | Porous NCA | CMC | Li—In | 3.68 V (Charging) | Li₂(OH)Cl | 0.5 | 88 |
| | (D₅₀ = 18 μm) | | | 1.38 V (Discharging) | (Melting point 292° C.) | | |
| Comparative | Porous Li₄Ti₅O₁₂ | PVDF | Li—In | 1.38 V (Charging) | Li₂(OH)Cl | 10.0 | 44 |
| example 1 | (D₅₀ = 8 μm) | | | 0.38 V (Discharging) | (Melting point 292° C.) | | |
| Comparative | Porous Li₄Ti₅O₁₂ | PVDF | Li—In | 1.38 V (Charging) | Li₇La₃Zr₂O₁₂ | 25.7 | 21 |
| example 2 | (D₅₀ = 3.91 μm) | | | 0.38 V (Discharging) | (Melting point 1550° C.) | | |

As indicated in Table 1, in each of Examples 1 and 2, the void rate was suppressed to a markedly low value and the cycle capacity retention rate after 100 cycles of charging and discharging had a high numerical value, as compared with those in Comparative examples 1 and 2. This indicates that it was possible to suppress an increase in resistance accompanying repeated charging and discharging even when the surface area of the active material particles was increased by adopting the active material particles having the porous structure. Typically, when a liquid electrolyte is used, increasing the surface area of active material particles causes a resistance to increase with increasing number of cycles. In contrast, regarding each of Examples 1 and 2, it is considered that the use of the hydrophilic binder allowed the pores of the active material particles to be sufficiently impregnated with the inorganic solid-state electrolyte, and thereby allowed a favorable interface to be formed between the active material particles and the inorganic solid-state electrolyte. This presumably made it possible to increase an area of an interface at which lithium as the electrode reactant reacted, and to thereby improve a lithium ion conductive property of the positive electrode.

Although the present disclosure has been described above with reference to one or more embodiments including modifications and Examples, the configuration of the present disclosure is not limited thereto, and is therefore modifiable in a variety of ways.

Specifically, in an embodiment, for example, the description has been given of the battery package 100 in which the solid-state battery 101 is placed on the support substrate 102A and is packaged; however, the battery package of the present disclosure is not limited to this embodiment. For example, in one embodiment, the support substrate may be omitted and sealing may be achieved merely by, for example, the insulating covering film and the inorganic covering film.

Further, in an embodiment above, the description has been given of the case where the electrode reactant is lithium; however, the electrode reactant is not particularly limited. Therefore, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present disclosure are not limited to those described herein. Accordingly, the present disclosure may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrode for a solid-state battery, the electrode comprising:
active material particles that each have a porous structure having a pore inside;
a binder provided in a gap between the active material particles, the binder comprising a hydrophilic organic compound; and
an inorganic solid-state electrolyte with which the pore is impregnated, the inorganic solid-state electrolyte being meltable at a temperature lower than a volatilization temperature of the binder.

2. The electrode for a solid-state battery according to claim 1, wherein the inorganic solid-state electrolyte is provided also in the gap between the active material particles.

3. The electrode for a solid-state battery according to claim 1, wherein the inorganic solid-state electrolyte is meltable at a temperature of higher than or equal to 200 degrees Celsius and lower than or equal to 400 degrees Celsius.

4. The electrode for a solid-state battery according to claim 1, wherein the binder comprises an organic compound including a functional group that includes OH at a terminal of the functional group.

5. The electrode for a solid-state battery according to claim 4, wherein the binder comprises a polyacrylic acid resin, a polyvinyl alcohol resin, a cellulose resin, or a phenol resin.

6. The electrode for a solid-state battery according to claim 1, wherein the binder comprises an acrylamide resin, an ester resin, an epoxy resin, or a melamine resin.

7. The electrode for a solid-state battery according to claim 1, wherein the pore has a dimension of greater than or equal to 10 nanometers and less than or equal to 500 nanometers.

8. The electrode for a solid-state battery according to claim 1, wherein the active material particles have a median diameter D50 of greater than or equal to 3 micrometers and less than or equal to 30 micrometers.

9. The electrode for a solid-state battery according to claim 1, wherein a proportion of a weight of the binder to a total weight of the electrode excluding the inorganic solid-state electrolyte is less than or equal to 3 percent.

10. The electrode for a solid-state battery according to claim 1, wherein a void rate in any section is less than 5 percent, the void rate in the section being a proportion of a total area of a void in the section to an area of all of the section.

11. The electrode for a solid-state battery according to claim 1, wherein the inorganic solid-state electrolyte comprises a lithium salt including at least one of Li₂CO₃, Li₂SO₄, Li₃BO₃, Li₃OCl, Li₂OHCl, Li₃OF, Li₃OBr, Li₃OI, Li₂OHF, Li₂OHBr, or Li₂OHI.

12. A method of manufacturing an electrode for a solid-state battery, the method comprising:
forming a slurry by mixing an active material particle, a binder, and a solvent with each other, the active material particle that has a porous structure having a pore inside, the binder comprising a hydrophilic organic compound;
forming a green sheet by applying the slurry onto a film and thereafter drying the slurry applied; and
impregnating the green sheet with an inorganic solid-state electrolyte dissolved at a temperature lower than a volatilization temperature of the binder.

13. A solid-state battery comprising:
a positive electrode;
a negative electrode; and
a solid-state electrolyte layer interposed between the positive electrode and the negative electrode; wherein
at least one of the positive electrode or the negative electrode includes
active material particles that each have a porous structure having a pore inside,
a binder provided in a gap between the active material particles, the binder comprising a hydrophilic organic compound, and
an inorganic solid-state electrolyte with which the pore is impregnated, the inorganic solid-state electrolyte being meltable at a temperature lower than a volatilization temperature of the binder.

14. The solid-state battery according to claim 13, wherein the inorganic solid-state electrolyte is provided also in the gap between the active material particles.

15. The solid-state battery according to claim 13, wherein the binder comprises an organic compound including a functional group that includes OH at a terminal of the functional group.

16. The solid-state battery according to claim 13, wherein
the solid-state electrolyte layer includes
a first solid-state electrolyte having a perovskite structure having a lattice constant that is an integer multiple of a value of greater than or equal to 3.8 angstroms and less than or equal to 4.1 angstroms, and
a second solid-state electrolyte having an antiperovskite structure having a lattice constant that is an integer multiple of a value of greater than or equal to 3.8 angstroms and less than or equal to 4.1 angstroms.

17. The solid-state battery according to claim 16, wherein
the first solid-state electrolyte includes electrolyte particles, and
the second solid-state electrolyte is provided between the electrolyte particles.

18. The solid-state battery according to claim 16, wherein
the first solid-state electrolyte comprises Li_{0.33}La_{0.56}TiO₃, and
the second solid-state electrolyte comprises Li₃OCl.

19. A battery package comprising:
a solid-state battery; and
a covering part covering the solid-state battery, wherein
the solid-state battery includes
a positive electrode,
a negative electrode, and
a solid-state electrolyte layer interposed between the positive electrode and the negative electrode, and
at least one of the positive electrode or the negative electrode includes
active material particles that each have a porous structure having a pore inside,
a binder provided in a gap between the active material particles, the binder comprising a hydrophilic organic compound, and
an inorganic solid-state electrolyte with which the pore is impregnated, the inorganic solid-state electrolyte being meltable at a temperature lower than a volatilization temperature of the binder.
